(19) United States
(12) Patent Application Publication
(10) Pub. No.: US 2005/0116910 A1
(43) Pub. Date: Jun. 2, 2005

(54) Video signal regulating module and method for mitigating flicker of an LCD device

(75) Inventors: Ming-Hsiu Lee, Hsinchu (TW); Scott Jen, Hsinchu (TW)

Correspondence Address: NIKOLAI & MERSEREAU, P.A., 900 SECOND AVENUE SOUTH, SUITE 820, MINNEAPOLIS, MN, 55402, US

(73) Assignee: VXIS TECHNOLOGY CORP., Hsinchu (TW)

(21) Appl. No.: 10/919,558

(22) Filed: Aug. 16, 2004

(30) Foreign Application Priority Data
Dec. 2, 2003 (TW) 92133804

(51) Int. Cl. G09G 5/00; G09G 3/36

(52) U.S. Cl. 345/87

(57) ABSTRACT

A video regulating module and method for mitigating flicker of an LCD device, wherein the method has acts of: supplying a pure color signal contained with brightness and gray scale information to the LCD device; measuring optical characteristics of the LCD device; generating compensating parameters directed to the pure color signal; and storing the compensating parameters in the LCD device. Therefore, when a video signal is input to the LCD device, the stored compensating parameters are applied to compensate the video signal to eliminate the flicker problem and obtain superior image quality.

### BACKGROUND OF THE INVENTION

1. Field of the Invention

The present invention relates to a video signal regulating module and method for mitigating flicker of a liquid crystal display device, and more particularly to a video signal regulating module and method which supplies predetermined compensating parameters to regulate an input video thus acquiring superior image quality.

2. Description of Related Art

With reference to FIG. 7, a TFT (thin-film transistor) LCD display device comprises an LCD display module (70) and a driving unit (80). The LCD display module (70) provides a plurality of horizontal signal driving ICs (71) and a plurality of vertical signal driving ICs (72) to control a liquid crystal panel (73), wherein each IC (71)(72) is controlled by the driving unit (80).

The driving unit (80) comprises a video processor (81), a timing generator (82) and a plurality of regulators (83-86). The video processor (81) performs synchronous separation and decoding by processing a video signal “VIDEO SOURCE” inputted from the exterior. Horizontal synchronizing signals (Hsync) and vertical synchronizing signals (Vsync) obtained by synchronous separation are sent to the timing generator (82). The timing generator (82) reversely supplies a field reverse pulse signal “FRP” to the video processor (81).

The video processor (81) converts the video signal demodulated by decoding into ac video signals supplied to the LCD display module (70) through the regulators (84, 85, 86) in accordance with the field reverse pulse signal FRP. These ac video signals consist of three primary color components: red (R), green (G) and blue (B). The voltage regulation circuit (83) supplies a counter voltage Vcom to the LCD display module (70). The LCD display module (70) is provided with a counter electrode and pixel electrodes both in contact with a liquid crystal layer of the liquid crystal panel (73). The counter voltage Vcom is applied to the counter electrode, while the regulated video signals R′,G′,B′ are applied to the pixel electrodes.

The liquid crystal panel (73) has liquid crystal pixels arranged in a matrix between the counter electrode and the pixel electrodes. As mentioned above, the horizontal signal driving ICs (71) and vertical signal driving ICs (72) are formed at the periphery of the liquid crystal panel (73). The vertical signal driving ICs (72), which operate in accordance with the vertical synchronizing signals Vsync, sequentially select each row of the liquid crystal pixels. The horizontal signal driving ICs (71), which operate in accordance with the horizontal synchronizing signals Hsync (71) write the video signals R′, G′, B′ to the selected row of the liquid crystal panel (73) by sequentially distributing them to each column of the liquid crystal pixels.

It is noted that the polarity of the driving voltage supplied to each thin-film transistor of each liquid crystal pixel must be continuously inverted. Some well-known polarity inversion methods include the dot inversion, the column inversion, the row inversion, the field inversion etc. The higher the inversion frequency supplied, the better image quality can be obtained. The voltage potential difference (dV) between the counter voltage Vcom and the video signals R′,G′,B′ applied to the liquid crystal pixel determines the presented brightness.

With reference to FIG. 8, the waveforms of the video signals R, G and B, the field reverse pulse FRP, the regulated video signals R′, G′ and B′, the counter voltage Vcom and the voltage potential difference dV are respectively illustrated. When either the video signals (R, G, B) or the counter voltage has potential level deviation, the flicker problem will occur on the liquid crystal panel (73). For example, the tints of black color are not dark enough and the brightness is too high to clearly present details of an image due to an over-high counter voltage Vcom.

With reference to FIG. 9, in another example, each of the three video signals (R, G and B) has a respective level so that when compared to the counter voltage Vcom, the respective voltage potential differences (dVr, dVg and dVb) accordingly occur. These respective voltage potential differences (dVr, dVg and dVb) mean that some of the red, green or blue color may be normally displayed, or possibly have the flicker problem.

In order to solve the foregoing problems, an optimization process is usually performed on the video signals and the counter voltage Vcom to acquire good display quality during the producing processes of the LCD display. According to the conventional ways, the optimization process for each color component and the counter voltage Vcom is achieved by fine tuning two variable resistors. After the completion of the adjustment, the variable resistors are sealed up to retain their adjusted status. The foregoing adjustment must be done by skilled operators, and involves complex, costly operations. Once the LCD device does not fit the requirement of the subsequent quality control, the variable resistors must be de-packaged to proceed resistance adjustment again.

Moreover, the adjustment of the variable resistors is only directed to the voltage level optimization, however the follow-up quality control (QC) is directed to examine the entire optical performance of the LCD display. Once the LCD device is not approved during the quality control due to other factors, the optimization becomes much more difficult and complicated.

### SUMMARY OF THE INVENTION

The objective of the present invention is to provide a video regulating system and method for mitigating flicker problem of an LCD device, wherein the regulating process is easily and efficiently accomplished to create and store a compensation table in the LCD device during its manufacturing procedures. Through the use of the compensate table, the flicker problem existing in the LCD device is able to be mitigated.

To achieve the objective, the method comprises acts of:
(a) supplying a pure color signal containing brightness and gray scale information to the LCD device;
(b) measuring optical characteristics of the LCD device;
(c) generating compensating parameters directed to the pure color signal;
(d) storing the compensating parameters in the LCD device; and
(e) repeating the acts of (a) to (d) until all three primary pure colors (R,G,B) are all processed,
whereby when a video signal is input to the LCD device, the stored compensating parameters are applied to compensate the video signal to mitigate the flicker.

Other objects, advantages, and unique features of the invention will become more apparent from the following detailed description and accompanying drawings.

### BRIEF DESCRIPTION OF THE DRAWINGS

FIG. 1 is a block diagram showing an optimizing system according to a first embodiment is applied to adjust an LCD device in accordance with the present invention;

FIG. 2 is a block diagram showing an optimizing system according to a second embodiment is applied to adjust an LCD device in accordance with the present invention;

FIG. 3 is a flowchart showing a part of manufacturing procedures of an LCD display device;

FIG. 4 is a flowchart of a video regulating method in accordance with the present invention;

FIG. 5 is block diagram of a video regulating method according to a first embodiment of the present invention;

FIG. 6 is block diagram of a video regulating method according to a first embodiment of the present invention;

FIG. 7 is a block diagram showing the architecture of a conventional LCD device;

FIG. 8 shows waveforms of video signals (R,G,B), a field reverse pulse (FRP), regulated video signals (R′,G′,B′), a counter voltage (Vcom), and a difference voltage (dV) generated in the LCD device of FIG. 7; and

FIG. 9 shows waveforms of video signals (R,G,B) with different voltage potentials and their respective difference voltages (dVr, dVg and dVb).

### DETAILED DESCRIPTION OF THE PREFERRED EMBODIMENT

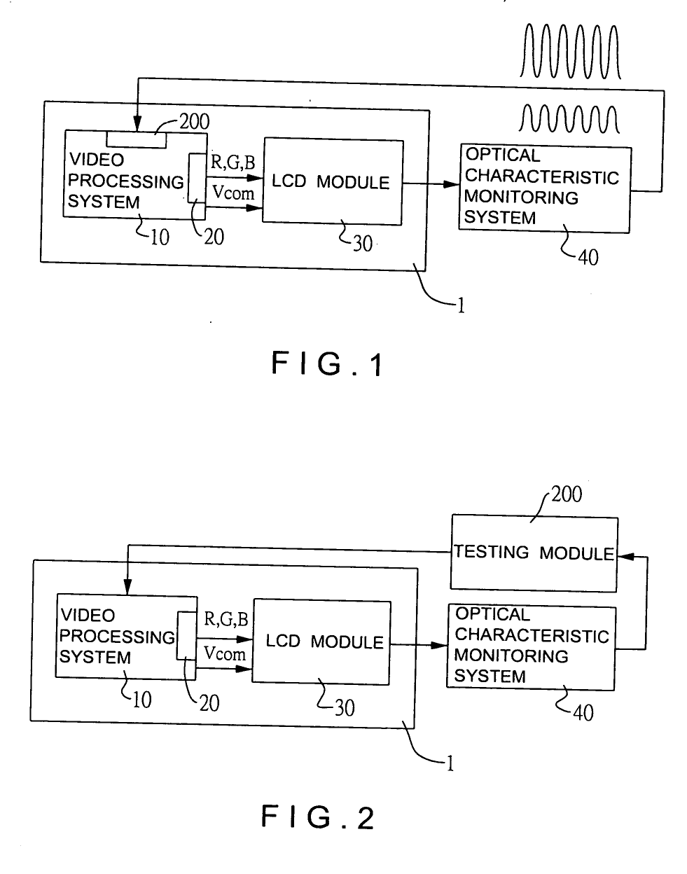

With reference to FIG. 1, an LCD display device (1) is composed of a video processing system (10) with a built-in video regulating module (20) in accordance with the present invention, a testing module built in the video processing system (10), and a liquid crystal display module (30). The testing module (200) can be constructed as an exterior independent module, not in the LCD display device (1), as shown in FIG. 2. An optical characteristic monitoring system (40) is coupled between the liquid crystal display module (30) and the testing module (200).

Based on the reception of a video signal, the video processing system (200) supplies three primary color components R, G, B and a counter voltage Vcom to the liquid crystal module (30). The optical characteristic monitoring system (40) measures the optical performance represented by the liquid crystal display module (30) and then outputs the measured data to the testing module. According to the measured data, the video regulating module (20) generates proper adjusting values to compensate the input video signal.

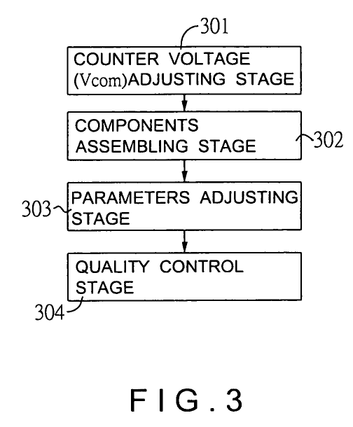

With reference to FIG. 3, the back-end manufacturing procedures of an TFT LCD display device mainly comprise a counter voltage (Vcom) adjusting stage (301), a components assembling stage (302), a parameters adjusting stage (303) and a subsequent quality control stage (304), wherein the present invention is utilized in the parameters adjusting stage (303).

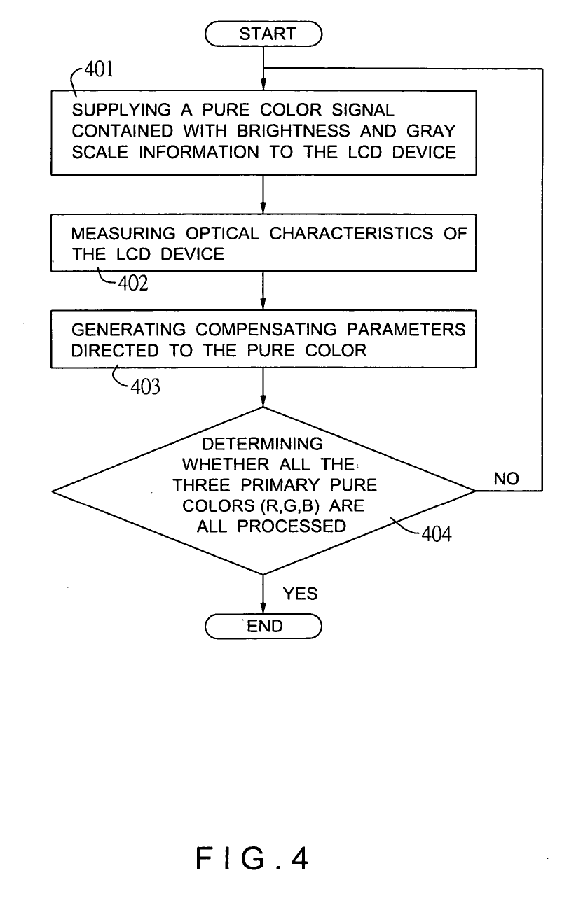

With reference to FIG. 4, the steps of the video signal regulating method of the present invention comprise the acts of: supplying a pure color signal contained with brightness and gray scale information (step 401) to the LCD device (1), measuring optical characteristics of the LCD device (1) (step 402), generating compensating parameters (step 403) directed to the pure color, and determining whether all the three primary pure colors (R,G,B) are all processed (step 404).

In more detail, the optical characteristic monitoring system (40) analyses and gathers the displayed image represented on the liquid crystal display module (30) to acquire the optical parameters, such as the brightness, the color saturation density etc. These gathered optical parameters are then supplied to the testing module (200). Based on the gathered optical parameters, the testing module (200) will calculate and determine the best compensating parameters. These compensating parameters can be provided to optimize the displayed image. Once these compensating parameters are determined, they are further stored in the video regulating module (20), referred to as a compensating table hereinafter.

When calculating and determining the best compensating parameters, the parameters can be preferably acquired through several well-known arts such as a full search method, an annealing method, a down-hill method etc. For example, when using the full search method, two ratio parameters (ratio 1, ratio 2) as well as two offset parameters (bias 1, bias 2) are adopted. All possible combinations of the four parameters (ratio 1, ratio 2) (bias 1, bias 2) are sequentially tested to determine which combination can obtain the compensated image quality.

Since the compensating parameters for all kinds of colors are stored in the video regulating module (20), the video signal input to the LCD display device (1) can be properly adjusted to present a superior image. In practical application, multiple video regulating modules (20) are set in the video processing system (10) to respectively adjust color components (R, G, B) of the video signal.

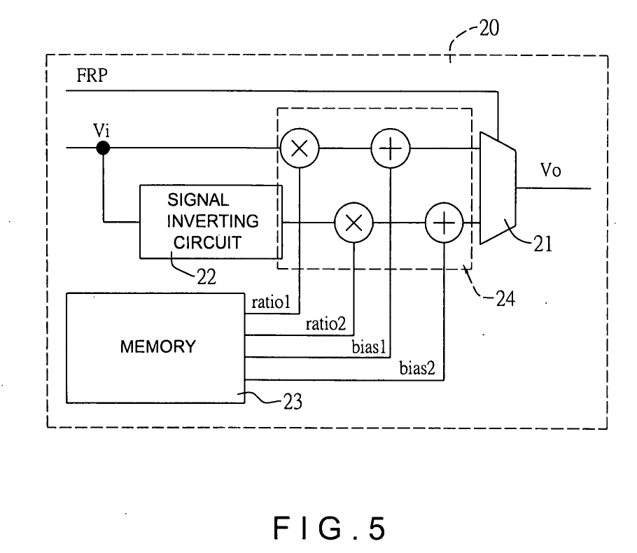

With reference to FIG. 5, a first embodiment of the video regulating module (20) comprises a multiplexer (21), a signal inverting circuit (22), a memory (23) and an operating unit (24).

The multiplexer (21) has two input terminals, a selecting terminal and an output terminal. When the video signal (Vi) is input, one input terminal receives the operated video signal through the operating unit (24) while the other input terminal receives the inverted video signal through the inverting circuit (22) and the operating unit (24). The selecting terminal receives the field reverse pulse (FRP) signal. Upon receiving the FRP signal, the multiplexer (21) selectively outputs either the non-inverted signal or the inverted video signal.

The memory (23) is used to store the compensating parameters created by the testing module (200).

The operating unit (24) according to the first embodiment is formed by two multipliers as well as two adders. The non-inverted video signal and the inverted video signal are respectively multiplied by two ratio values (ratio 1, ratio 2) by the two multipliers. Two offset values (bias 1, bias 2) are then respectively added to the multiplied video signals.

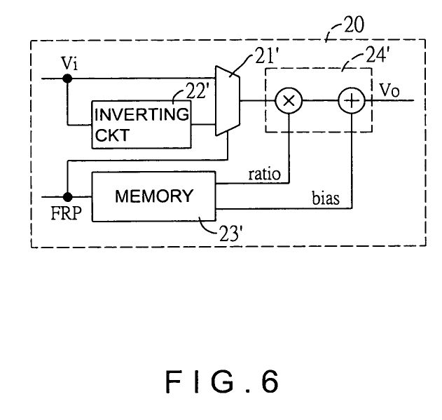

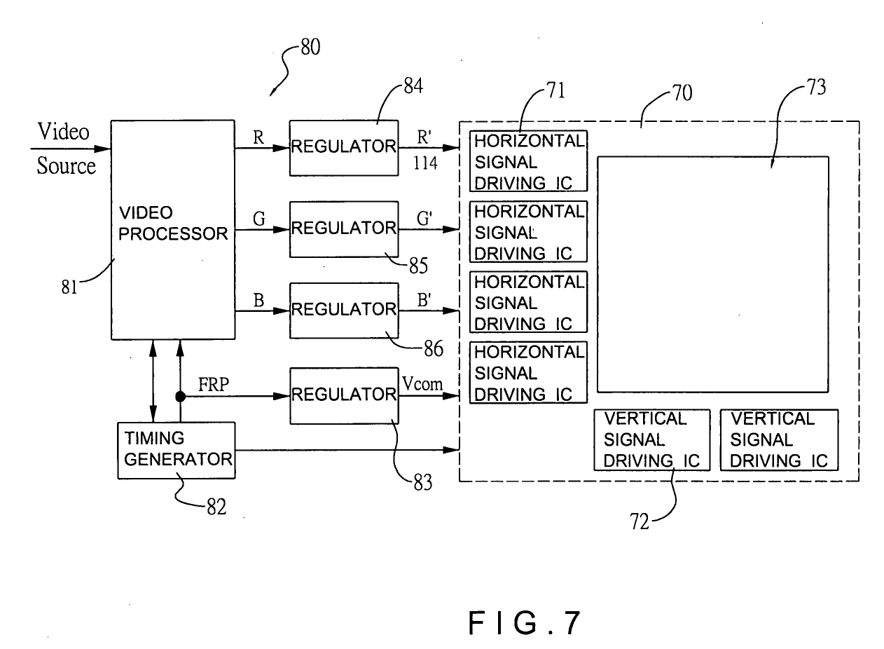

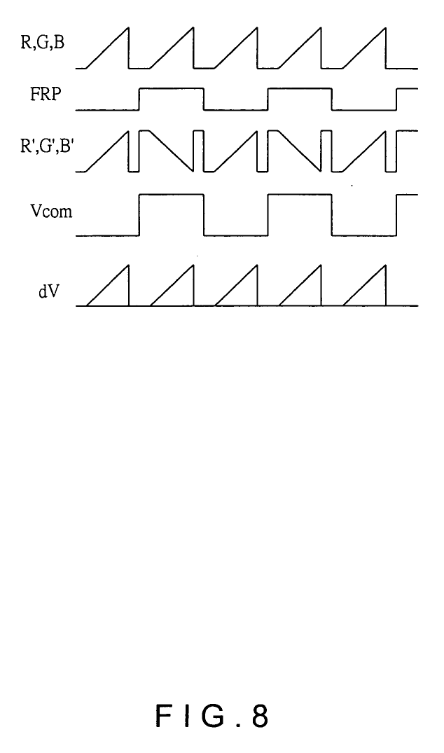

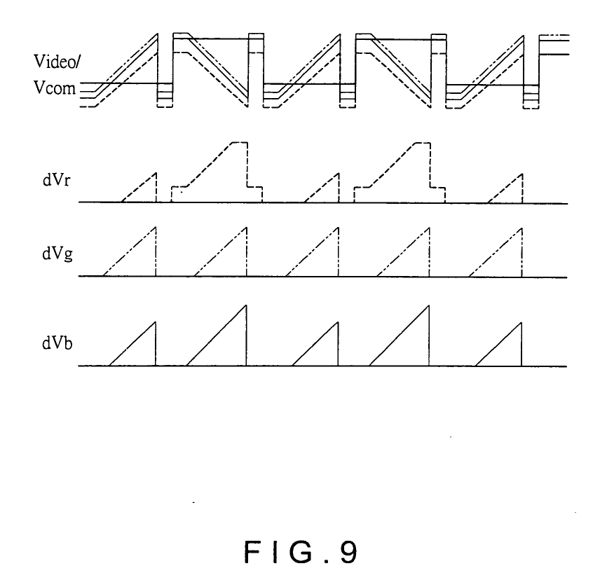

With reference to FIG. 6, a second embodiment of the video regulating module (20) comprises a multiplexer (21′), a signal inverting circuit (22′), a memory (23′) and an operating unit (24′).

The multiplexer (21′) has two input terminals, a selecting terminal and an output terminal. One of the input terminals directly receives the video signal, and the other input terminal receives the inverted video signal through the inverting circuit (22). The selecting terminal receives the field reverse pulse (FRP) signal. Upon receiving the FRP signal, the multiplexer (21′) selectively outputs either the non-inverted signal or the inverted video signal.

The memory (23′) is used to store the compensating parameters.

The operating unit (24′) is coupled to the output terminal of the multiplexer (21′), wherein the operating unit (24′) is formed by a multiplier and an adder. The output of the multiplexer (21′) is multiplied by a ratio value and further added with an offset value offered from the memory (23′).

According to the foregoing description, the optimization process for the LCD device is easily and efficiently accomplished. For each color signal, a respective compensating parameter is stored in the LCD device. Therefore, when in use, the flicker problem can be effectively mitigated to represent superior image quality.

It is to be understood, however, that even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A video signal regulating method for mitigating flicker of an LCD device, the method comprising acts of:
(a) supplying a pure color signal contained with brightness and gray scale information to the LCD device;
(b) measuring optical characteristics of the LCD device;
(c) generating compensating parameters directed to the pure color signal;
(d) storing the compensating parameters in the LCD device; and
(e) repeating the acts of (a) to (d) until all three primary pure colors (R,G,B) are all processed;
whereby when a video signal is input to the LCD device, the stored compensating parameters are applied to compensate the video signal to mitigate the flicker.

2. A video signal regulating module for mitigating flicker of an LCD device, the video regulating module comprising:
a multiplexer (21) having a selecting terminal, an output terminal and two input terminals that receive a video signal through an operating unit (24), wherein one input terminal receives the non-inverted video signal and the other input terminal receives the inverted video signal; wherein the selecting terminal receives a field reverse pulse (FRP) signal upon which the multiplexer (21) selectively outputs the received signal from one of the two input terminals;
a memory that stores compensating parameters and supplies the compensating parameters to the operating unit (24);
wherein the operating unit (24) is coupled to the two input terminals of the multiplexer (21) to perform compensation on the non-inverted video signal and the inverted video signal, and then the compensated non-inverted video signal and the inverted video signal are input to the multiplexer (21) through the two input terminals, respectively.

3. The video signal regulating module as claimed in claim 2, wherein the operating unit (24) is formed by two multipliers and two adders, wherein the non-inverted video signal and the inverted video signal are respectively multiplied by two ratio values (ratio 1, ratio 2), and two offset values (bias 1, bias 2) are then respectively added to the multiplied video signals.

4. The video signal regulating module as claimed in claim 2, wherein the video signal is one of the three primary color signals.

5. The video signal regulating module as claimed in claim 2, wherein the video signal regulating module is created in the LCD device.

6. The video signal regulating module as claimed in claim 2, wherein an inverting circuit (22) is coupled between the video signal and one of the two input terminals of the multiplexer.

7. A video signal regulating module for mitigating flicker of an LCD device, the video regulating module comprising:
a multiplexer (21′) having a selecting terminal, an output terminal and two input terminals, wherein one of the input terminals directly receives the video signal and the other input terminal receives the inverted video signal; wherein the selecting terminal receives a field reverse pulse (FRP) signal upon which the multiplexer (21′) selectively outputs the received signal from one of the two input terminals;
an operating unit (24′) coupled to the output terminal of the multiplexer (21′) to perform compensation on a video signal output from the multiplexer; and
a memory (23′) storing compensating parameters and supplying the compensating parameters to the operating unit (24′);

8. The video signal regulating module as claimed in claim 7, wherein the operating unit (24′) is formed by a multiplier and an adder, wherein the video signal output from the multiplexer (21′) is multiplied by a ratio value and then added by an offset value.

9. The video signal regulating module as claimed in claim 7, wherein the video signal is one of the three primary color signals.

10. The video signal regulating module as claimed in claim 7, wherein the video signal regulating module is created in the LCD device.

11. The video signal regulating module as claimed in claim 7, wherein an inverting circuit (22′) is coupled between the video signal and one of the two input terminals of the multiplexer.
